(19) United States
(12) Patent Application Publication
(10) Pub. No.: US 2018/0304838 A1
(43) Pub. Date: Oct. 25, 2018

(54) Vehicle Bumper System

(71) Applicant: James Cummings, Enid, OK (US)

(72) Inventor: James Cummings, Enid, OK (US)

(21) Appl. No.: 15/492,096

(22) Filed: Apr. 20, 2017

(51) Int. Cl. B60R 19/02; B60R 19/50; B60Q 1/00

(52) U.S. Cl. CPC B60R 19/023; B60R 2019/505; B60Q 1/0035; B60R 19/50

(57) ABSTRACT

A vehicle bumper system includes a vehicle that has a front end, a bottom side and a pair of front wheels. A bumper is mounted to the front end of the vehicle to absorb impact energy from a collision. The bumper is positioned lower than the bottom side of the vehicle to frictionally engage ground when the vehicle travels over a depression. In this way the bumper inhibits the bottom side of the vehicle from engaging the ground. The bumper has a first well and a winch is selectively mounted therein.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bumper devices and more particularly pertains to a new bumper device for serving as an OEM replacement and aftermarket add on with respect to a vehicle.

### BRIEF SUMMARY OF THE INVENTION

An embodiment of the disclosure meets the needs presented above by generally comprising a vehicle that has a front end, a bottom side and a pair of front wheels. A bumper is mounted to the front end of the vehicle to absorb impact energy from a collision. The bumper is positioned lower than the bottom side of the vehicle to frictionally engage ground when the vehicle travels over a depression. In this way the bumper inhibits the bottom side of the vehicle from engaging the ground. The bumper has a first well and a winch is selectively mounted therein.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a bumper of a vehicle bumper system according to an embodiment of the disclosure.

FIG. 2 is a left side view of bumper of an embodiment of the disclosure.

FIG. 3 is a back view of bumper of an embodiment of the disclosure.

FIG. 4 is a front in-use view of an embodiment of the disclosure.

FIG. 5 is a back in-use view of an embodiment of the disclosure.

FIG. 6 is a top view of rear bumper of an embodiment of the disclosure.

### DETAILED DESCRIPTION OF THE INVENTION

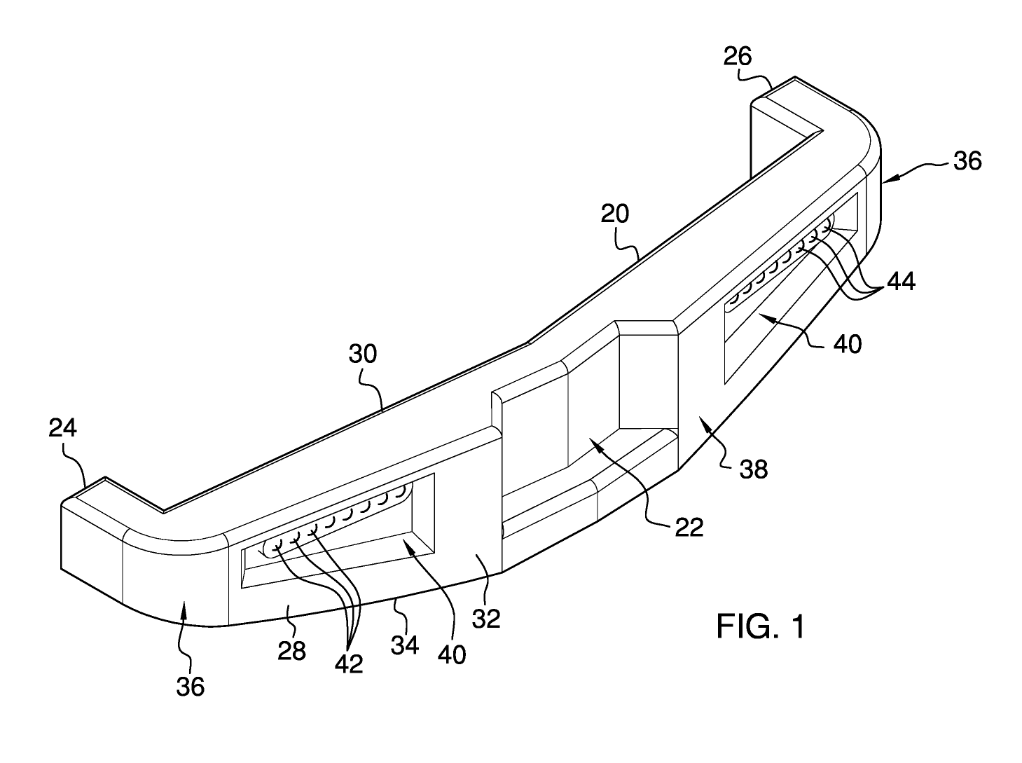

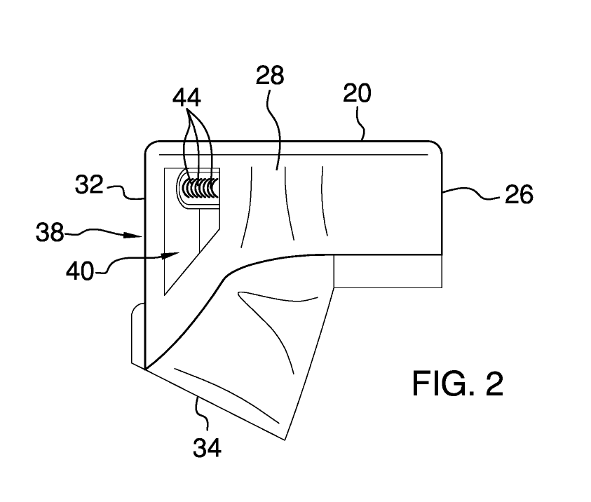

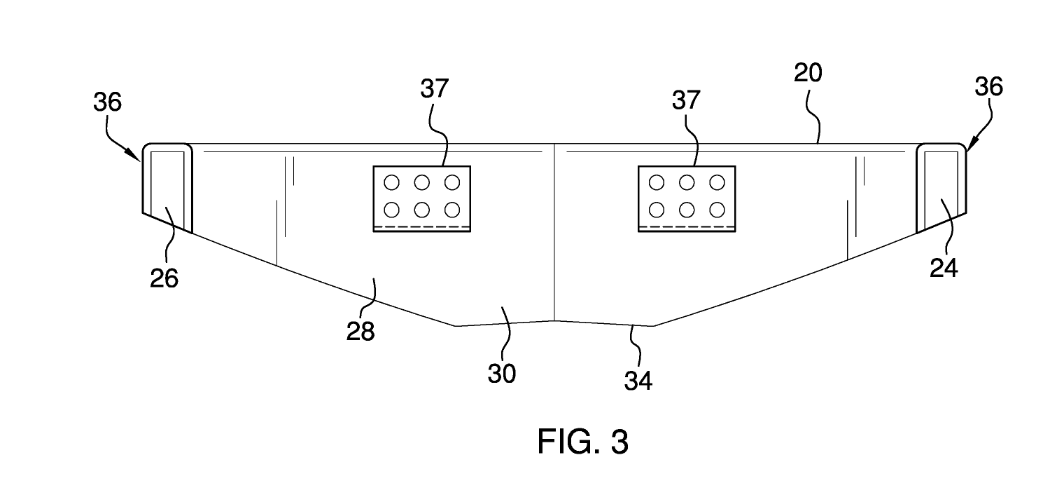

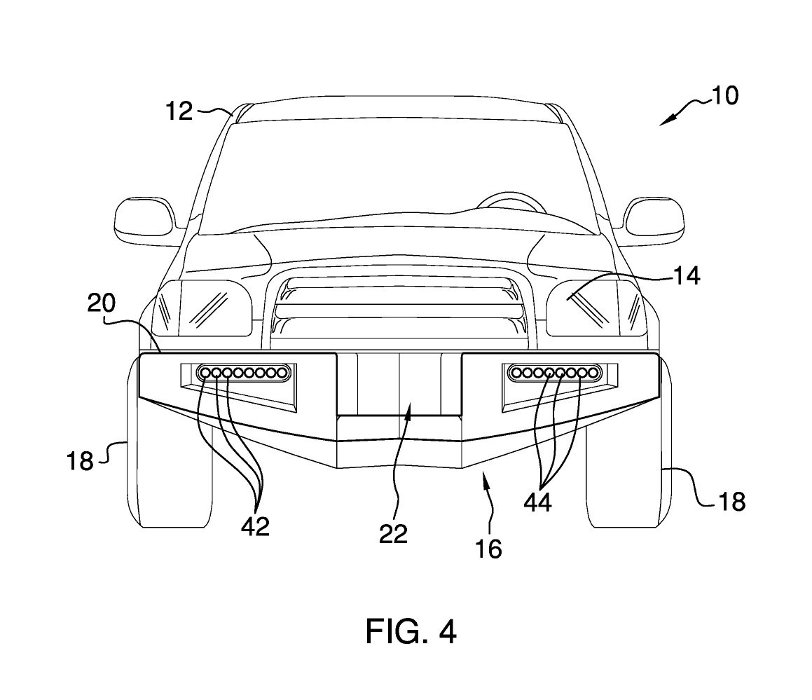

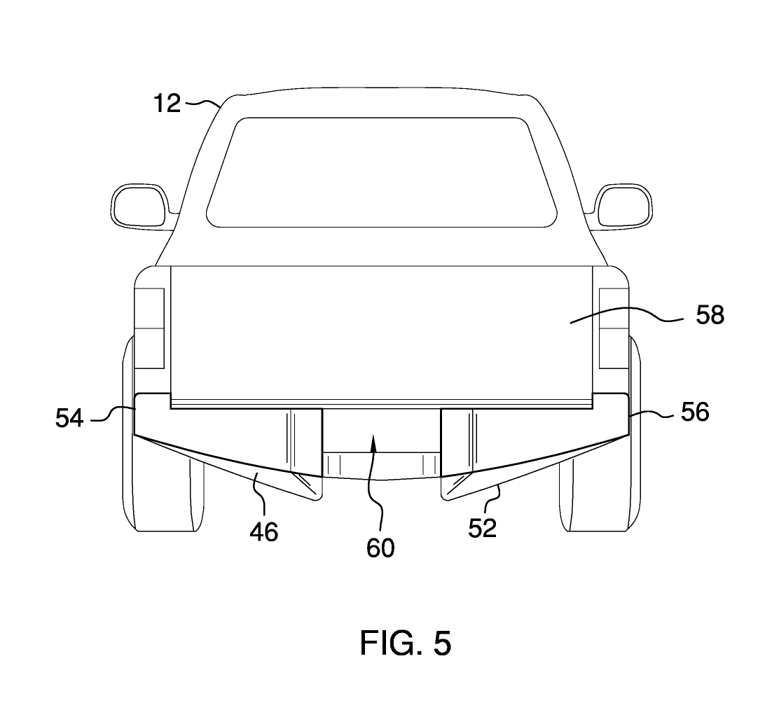

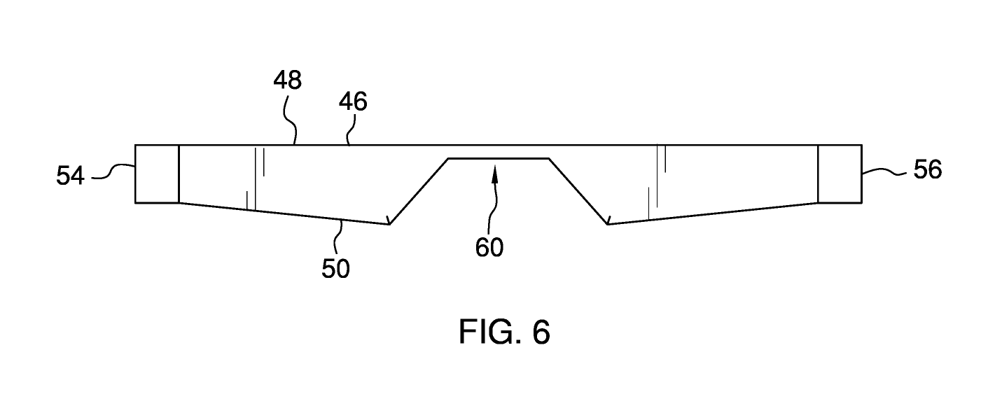

With reference now to the drawings, and in particular to FIGS. 1 through 6 thereof, a new bumper device embodying the principles and concepts of an embodiment of the disclosure and generally designated by the reference numeral 10 will be described.

As best illustrated in FIGS. 1 through 6, the vehicle bumper system 10 generally comprises a vehicle 12 has a front end 14, a bottom side 16 and a pair of front wheels 18. The vehicle 12 may be a passenger vehicle 12 to include, but not be limited to, a pickup or other type of truck. A bumper 20 is mounted to the front end 14 of the vehicle 12 to absorb impact energy from a collision. Moreover, the bumper 20 is positioned lower than the bottom side 16 of the vehicle 12 to frictionally engage ground when the vehicle 12 travels over a depression. In this way the bumper 20 inhibits the bottom side 16 of the vehicle 12 from engaging the ground. The bumper 20 has a first well 22 therein and a winch may be positioned in the first well 22.

The bumper 20 has a first end 24, a second end 26 and an outer wall 28 extending therebetween. The outer wall 28 has a rear side 30, a forward side 32 and a lower side 34. Additionally, the outer wall 28 has a pair of bends 36 thereon and the bends 36 are spaced apart from each other. Thus, each of the first end 24 and the second end 26 are directed rearwardly from a central portion 38 of the bumper 20. The central portion 38 of the bumper 20 has a width that is equal to a width of the vehicle 12.

Moreover, the rear side 30 is attached to the front end 14 of the vehicle 12 having each of the first end 24 and the second end 26 being directed toward an associated one of the front wheels 18. Each of the first end 24 and the second end 26 is spaced from the associated front wheel 18 thereby inhibiting the associated front wheel 18 from frictionally engaging the bumper 20 when the vehicle 12 is turning. A pair of mounting plates 37 is provided and each of the mounting plates 37 is coupled to the rear side 30 of the bumper 20. Each of the mounting plates 37 is attached to the front end 14 of the vehicle 12 using fasteners, welds or any other conventional means of mechanical fastening.

The lower side 34 is positioned lower than bottom side 16 of the vehicle 12 to frictionally engage the ground when the vehicle 12 travels over the depression. Moreover, the lower side 34 angles downwardly between the forward side 32 and the rear side 30 of the bumper. Thus, the lower side 34 gradually urges the vehicle 12 upwardly from the ground when the lower side 34 engages the ground. The lower side 34 additionally angles downwardly between each of the bends 36. The forward side 32 corresponding to the central portion 38 has the first well 22 extending toward the rear side 30 and the first well 22 is centrally positioned between the bends 36. The forward side 32 corresponding to the central portion 38 has a pair of second wells 40 extending toward the rear side 30. Each of the second wells 40 is positioned between the first well 22 and an associated one of the bends 36.

A plurality of first light emitters 42 is provided and each of the first light emitters 42 is coupled to the forward side 32 of the bumper 20. Each of the first light emitters 42 selectively emits light outwardly therefrom. Moreover, each of the first light emitters 42 is positioned in an associated one of the second wells 40 and each of the first light emitters 42 is electrically coupled to the vehicle 12. Each of the first light emitters 42 may comprise an LED or the like.

A plurality of second light emitters 44 is provided and each of the second light emitters 44 is coupled to the forward side 32 of the bumper 20. Each of the second light emitters 44 selectively emits light outwardly therefrom. Each of the second light emitters 44 is positioned in an associated one of the second wells 40 and each of the second light emitters 44 is electrically coupled to the vehicle 12. Additionally, each of the second light emitters 44 may comprise an LED or the like.

A rear bumper 46 is provided and the rear bumper 46 has a rearmost side 48, a frontmost side 50, a lowermost side 52, a primary end 54 and a secondary end 56. The rear bumper 46 is mounted to a back end 58 of the vehicle 12. The frontmost side 50 of the rear bumper 46 has a depression 60 extending toward the rearmost side 48. Additionally, the lowermost side 52 angles downwardly between each of the primary 54 and secondary 56 ends and the depression 60.

In use, the bumper 20 is mounted the front side of the vehicle 12 as an aftermarket add on or OEM replacement. The winch is mounted in the first well 22 and each of the first 42 and second 44 light emitters is electrically coupled to the vehicle 12. The lower side 34 of the bumper 20 serves as a skid plate when the vehicle 12 drives over a depression thereby inhibiting the bottom side 16 of the vehicle 12 from engaging the ground. Additionally, each of the first 24 and second 26 ends of the bumper 20 are spaced a sufficient distance from the associated front wheel 18 to inhibit the associated front wheel 18 from engaging the bumper 20 when the vehicle 12 is turning. Moreover, the spacing of the first end 24 and the second end 26 with respect to the front wheels 18 facilitate over-sized, aftermarket wheels to be mounted to the vehicle 12 without engaging the bumper 20. Each of the first 42 and second 44 light emitters is turned on in conjunction with the vehicle's lighting system to augment lighting in a darkened environment.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle bumper system comprising:
a vehicle having a front end, a bottom side and a pair of front wheels; and
a bumper being mounted to said front end of said vehicle wherein said bumper is configured to absorb impact energy from a collision, said bumper being positioned lower than said bottom side of said vehicle wherein said bumper is configured to frictionally engage ground when said vehicle travels over a depression thereby inhibiting said bottom side of said vehicle from engaging the ground, said bumper having a first well therein wherein said first well is configured to have a winch positioned therein, said bumper having a first end, a second end and an outer wall extending therebetween, said outer wall having a rear side, a forward side and a lower side, said outer wall having a pair of bends thereon, said bends being spaced apart from each other such that each of said first end and said second end are directed rearwardly from a central portion of said bumper, said rear side being attached to said front end of said vehicle having each of said first end and said second end being directed toward an associated one of said front wheels, said lower side being positioned lower than bottom side of said vehicle wherein said lower side is configured to frictionally engage the ground when said vehicle travels over the depression.

2. (canceled)

3. The system according to claim 1, wherein each of said first end and said second end is spaced from said associated front wheel thereby inhibiting said associated front wheel from frictionally engaging said bumper when said vehicle is turning.

4. (canceled)

5. The system according to claim 1, further comprising said forward side corresponding to said central portion having said first well extending toward said rear side, said first well being centrally positioned between said bends.

6. The system according to claim 5, wherein said forward side corresponding to said central portion has a pair of second wells extending toward said rear side, each of said second wells being positioned between said first well and an associated one of said bends.

7. The system according to claim 6, further comprising a plurality of first light emitters, each of said first light emitters being coupled to said forward side of said bumper wherein each of said first light emitters is configured to emit light outwardly therefrom, said first light emitters being positioned in a first one of said second wells, each of said first light emitters being electrically coupled to said vehicle.

8. The system according to claim 7, further comprising a plurality of second light emitters, each of said second light emitters being coupled to said forward side of said bumper wherein each of said second light emitters is configured to emit light outwardly therefrom, said second light emitters being positioned in a second one of said second wells, each of said second light emitters being electrically coupled to said vehicle.

9. A vehicle bumper system comprising:
a vehicle having a front end, a bottom side and a pair of front wheels; and
a bumper being mounted to said front end of said vehicle wherein said bumper is configured to absorb impact energy from a collision, said bumper being positioned lower than said bottom side of said vehicle wherein said bumper is configured to frictionally engage ground when said vehicle travels over a depression thereby inhibiting said bottom side of said vehicle from engaging the ground, said bumper having a first well therein wherein said first well is configured to have a winch positioned therein, said bumper having a first end, a second end and an outer wall extending therebetween, said outer wall having a rear side, a forward side and a lower side, said outer wall having a pair of bends thereon, said bends being spaced apart from each other such that each of said first end and said second end are directed rearwardly from a central portion of said bumper, said rear side being attached to said front end of said vehicle having each of said first end and said second end being directed toward an associated one of said front wheels, each of said first end and said second end being spaced from said associated front wheel thereby inhibiting said associated front wheel from frictionally engaging said bumper when said vehicle is turning, said lower side being positioned lower than bottom side of said vehicle wherein said lower side is configured to frictionally engage the ground when said vehicle travels over the depression, said forward side corresponding to said central portion having said first well extending toward said rear side, said first well being centrally positioned between said bends, said forward side corresponding to said central portion having a pair of second wells extending toward said rear side, each of said second wells being positioned between said first well and an associated one of said bends;
a plurality of first light emitters, each of said first light emitters being coupled to said forward side of said bumper wherein each of said first light emitters is configured to emit light outwardly therefrom, said first light emitters being positioned in a first one of said second wells, each of said first light emitters being electrically coupled to said vehicle; and
a plurality of second light emitters, each of said second light emitters being coupled to said forward side of said bumper wherein each of said second light emitters is configured to emit light outwardly therefrom, said second light emitters being positioned in a second one of said second wells, each of said second light emitters being electrically coupled to said vehicle.
